(19) United States
(12) Patent Application Publication
(10) Pub. No.: US 2016/0363952 A1
(43) Pub. Date: Dec. 15, 2016

(54) CONTROL OF A SERIES PASS CIRCUIT FOR REDUCING SINGING CAPACITOR NOISE

(71) Applicant: Apple Inc., Cupertino, CA (US)

(72) Inventors: Ryan J. Garrone, San Francisco, CA (US); Nicholas J. Kunst, San Francisco, CA (US); Jim Z. Huang, San Jose, CA (US)

(21) Appl. No.: 14/736,908

(22) Filed: Jun. 11, 2015

(51) Int. Cl. G05F 5/00; H02J 7/00

(52) U.S. Cl. CPC G05F 5/00; H02J 7/007; H02J 7/0063

(57) ABSTRACT

A series pass circuit conducts a pass current between a first side and a second side. A power source is coupled to the first side, while a capacitor is coupled to the second side. A system component whose power supply input is coupled to the capacitor may exhibit pulse-type activity. A control circuit increases the resistance to the pass current, in the series pass circuit, in accordance with a reporting signal that indicates whenever the system component is more active or less active. Other embodiments are also described and claimed.

### FIELD

An embodiment of the invention is directed to avoiding the “singing capacitor” effect in a portable electronic device, in which acoustic noise is caused by the piezo-electric effect in a capacitor that is being subjected to a time-varying signal in the audible frequency range (e.g., non-sinusoidal waveforms such as sawtooth or square waves, pure sinusoidal signals, and ripple voltage, with our without a dc component). Other embodiments are also described.

### BACKGROUND

In the context of a portable electronic communications device, such as a smartphone, for example, certain types of capacitors can create an acoustic annoyance to the user. The density of rigid components inside the device housing, coupled with voltage swings across a multi-layer ceramic capacitor that has been soldered to a printed circuit board (as a power supply decoupling capacitor) may lead to the user hearing a buzz that is created by the piezo-electric effect in the capacitor causing vibration. Solutions to such a problem include adding passive acoustic damping material around the capacitor as installed on a printed circuit board, or designing the capacitor itself to have a lesser tendency to vibrate.

### SUMMARY

An embodiment of the invention addresses the singing capacitor problem from a system point of view, rather than at the capacitor component level. In one embodiment, a series pass circuit conducts a pass current between a first side and a second side. A power source is coupled to the first side, while a capacitor (a potentially singing capacitor) is coupled to the second side. A system component has its power supply input coupled to the capacitor, e.g. for decoupling or power supply bypass purposes. A control circuit is coupled to a control input of the series pass circuit so as to increase the latter's resistance to the pass current, in accordance with a reporting signal that indicates whenever the system component is more active or less active. In this way, transients in the current through the capacitor, which may be caused by pulse-type activity of the system component, have smaller amplitude (while changes in the capacitor voltage are slowed down). This may sufficiently reduce the sound produced by the otherwise singing capacitor (in the audible frequency range).

In another embodiment, the singing capacitor problem is addressed in a portable electronic device, as follows. The portable device has a battery that provides a battery discharging current, to the power supply input of a system component, through a series pass circuit. A capacitor is directly connected to the power supply input of the system component. The capacitor may potentially become a singing capacitor and create acoustic noise, during pulsing-type operating modes of the portable device, which create voltage spikes across the capacitor. A power supply circuit provides a battery charging current through the series pass circuit. A battery charging control circuit is coupled to control the series pass circuit so as to modulate the battery charging current, into the battery, via the series pass circuit.

A noise reduction control circuit is also coupled to control the series pass circuit; the noise reduction circuit modulates the battery discharging current out of the battery, via the series pass circuit. This may be achieved by modulating the resistance of the series pass circuit to the pass current. In one embodiment, this is done while an external power source (e.g., a Universal Serial Bus power adapter) is unplugged from the portable device, such that the pass current is essentially the load current (drawn by one or more system components) which may be essentially the discharge current being supplied by the battery. In this operating mode, the voltage across the capacitor of concern (e.g., serving as a local energy storage device for the power supply input of one or more of the system components) will exhibit slower changes, while the capacitor current exhibits smaller transients. This has been found to sufficiently reduce the sound produced by the capacitor, in the audible frequency range.

In one embodiment, the resistance of the series pass circuit is varied (under control of the noise reducer circuit) as needed to reduce the charging rate of the capacitor, each time there is a large drop in the load current which causes the capacitor to otherwise be rapidly charged by the battery discharge current. In one embodiment, such large drops in the load current are essentially periodic and are caused by the pulse type activity of a radio communications transceiver that is one of the system components. For example, in the case of a Global System for Mobile Communications (GSM) transceiver, the periodic large drops may be due to pulse type activity exhibited by time division multiple access (TDMA) operation of the transceiver, for example at a frequency of 217 Hz. Such pulse type activity would otherwise lead to an audible buzz at 217 Hz created by the capacitor vibrating at the same frequency. Note however that the concepts described here are applicable to other pulse type activity by one or more system components (that cause sufficiently large changes in the power supply input currents of those system components).

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, a given figure may be used to illustrate the features of more than one embodiment of the invention, and not all elements in the figure may be required for a given embodiment.

FIG. 1 is a block diagram of an electronic system that contains a potential singing capacitor.

FIG. 2 shows example waveforms of input current, capacitor voltage, and capacitor current as they may be exhibited by an embodiment of the invention.

FIG. 3 is a block diagram of a portable electronic system having a potential singing capacitor.

FIG. 4 illustrates an example power supply circuit that provides the battery charging current in the embodiment of FIG. 3.

FIG. 5 depicts an example portable electronic system in use, namely a mobile phone that is being used in its handset mode.

### DETAILED DESCRIPTION

Several embodiments of the invention with reference to the appended drawings are now explained. Whenever aspects of the embodiments described here are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

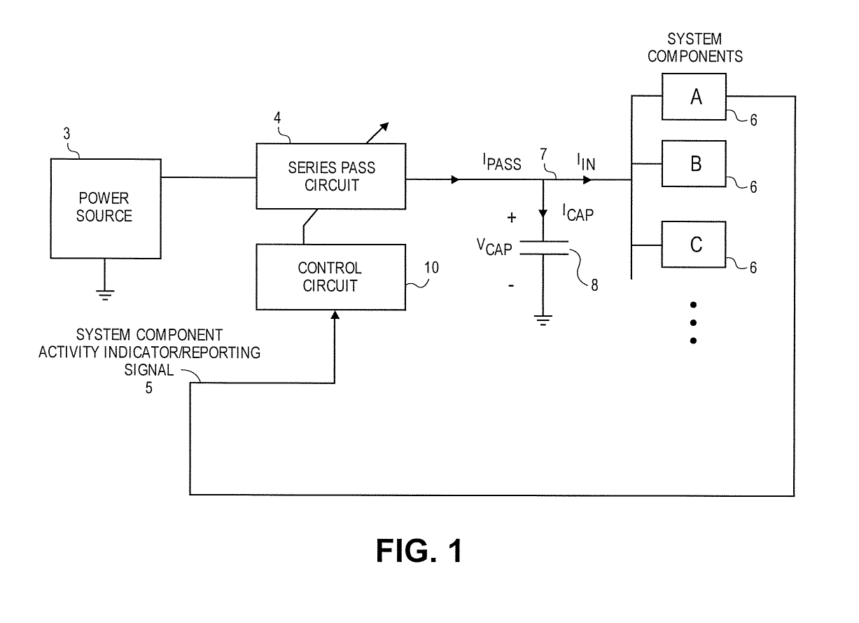

FIG. 1 is a combined circuit schematic and block diagram of an electronic system that contains a capacitor 8 that may become a potentially singing capacitor during otherwise normal operation of the system. The capacitor 8 may be, for example, a multi-layer ceramic capacitor, that is mounted conventionally to a printed circuit board, via for example soldering of its terminals directly to contact pads formed in an outer surface of the printed circuit board (not shown). One terminal of the capacitor 8 is, in this case, directly connected to a common node 7 which is a power supply node that is shared by or is common to several other components, including a number of system components 6 (A, B, C . . . ) while another terminal is directly connected to a power supply return node, here ground. Although not shown, the node 7 and its connected current branches may be implemented in one or more wiring layers of the printed circuit board to which the terminals of the capacitor 8 may be soldered or otherwise conductively bonded.

A first side of a series pass circuit 4 is coupled to a power source 3, while a second side of the series pass circuit 4 is directly connected to the common node 7. The power source 3 may be a battery, or it may be a power supply circuit that is receiving power from an ac power line (e.g., a consumer electronics ac wall power adapter, or an electric power generator) or it may be a dc-dc converter system, such as a low drop out voltage regulator, or a boost converter. In this case, the power source 3 is shown as having its power return node be the same ground as used the capacitor 8, and by one or more of the system components 6. In other embodiments, such as in a dual power supply system, the power return node shared by the power source 3 and the capacitor 8 may be a negative power supply node.

The arrangement in FIG. 1 allows the series pass circuit 4 to conduct a pass current Iₚₐₛₛ between a first side and a second side of the series pass circuit 4 as shown, in accordance with a control input. A control circuit 10 is coupled to the control input of the series pass circuit 4 as shown, and is able to signal an increase in the resistance to the pass current, in the series pass circuit 4. This may be done in accordance with, or in response to, a reporting signal 5 received by the control circuit 10, which indicates the level of activity of a system component 6, such as when the system component 6 is either more active or less active, e.g. consuming more power versus less power. In the example shown in FIG. 1, the reporting signal 5 may be produced by one of the system components 6 (A), as a digital reporting signal that, for example, may have two stable states, one that indicates more activity and another that indicates less activity by that particular system component 6(A). Alternatively, the reporting signal may provide finer granularity on the activity level, e.g. reporting on three or more different levels of activity or power consumption. In another embodiment, the reporting signal 5 may be generated by one of the system components 6(A) on behalf of another system component 6(B), for example, by a power management circuit that is responsible for overseeing the distribution of power or consumption of power by one or more of the other system components 6 in the electronic system. Thus, the reporting signal 5 need not indicate the activity level of the particular component 6 from which it is being generated, but rather may indicate the activity level of another component 6 or an overall activity level for all of the system components 6 or a number of such system components 6 (where at least one or more of such system components 6 have a power supply input that is coupled to the capacitor 8, and in particular directly connected to the common node 7 as shown).

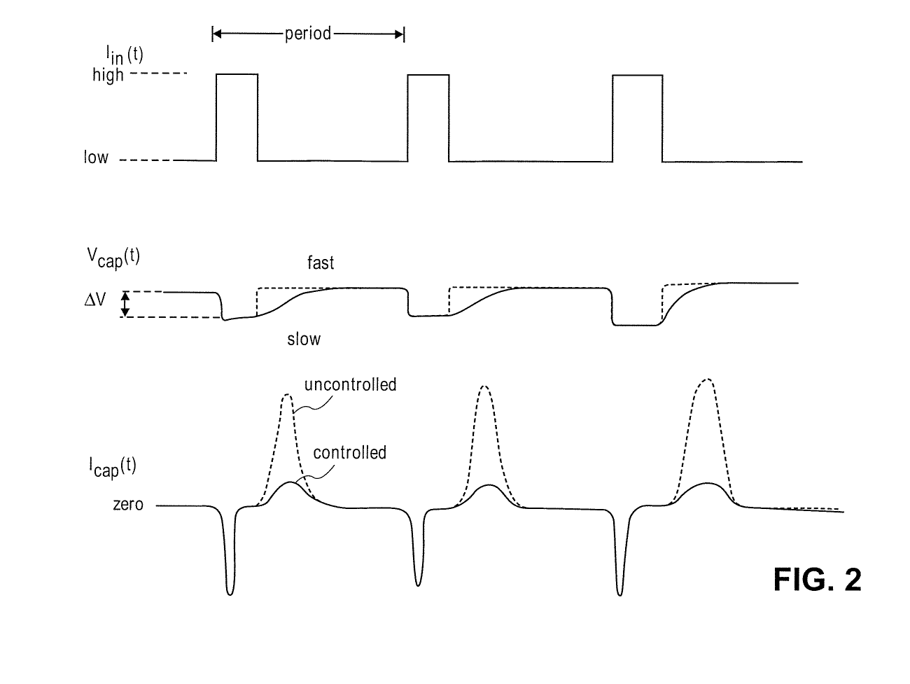

Still referring to FIG. 1, the common node 7 has in this example three branches for conducting current, including an incoming pass current Iₚₐₛₛ, an outgoing capacitor current I_{cap} and another outgoing current Iᵢₙ which is the current being drawn by the power supply inputs of the system components 6 (also referred to here as “load current”). Viewed in this manner, operation of the system in FIG. 1 and in particular the effect of controlling the resistance to the pass current in the series pass circuit 4 can be understood with reference to the timing diagram in FIG. 2. In that timing diagram, there are three waveforms that are shown, namely Iᵢₙ, V_{cap}, and I_{cap}, all as a function of time. The waveform for Iᵢₙ depicts the pulse-type activity of one or more of the system components 6, as reflected in their power supply input currents which may be summed to be Iᵢₙ. Generally, pulse-type activity refers to abrupt and large changes in power supply input current of one or more of the system components 6, reflected in the load current, Iᵢₙ, which swings from a low current level to a high current level and back, periodically. The period and shape of the waveform translates to a frequency component or components at multiple frequencies (harmonics) that are in the audible human range. As mentioned above in the Summary, in one embodiment, the pulse-type activity is that of a radio communications transceiver that may be one of the system components 6. For example, in the case of a GSM transceiver, the periodic and large rises and drops in the current Iᵢₙ are due to primarily the pulse-type activity exhibited by TDMA operation of the transceiver, for example at a frequency of 217 Hz (corresponding to 1/period). Such pulse-type activity results in a large enough swing in V_{cap} that would typically lead to an audible buzz with a fundamental frequency of 217 Hz (created by the capacitor 8 vibrating at the same frequency).

The changing current Iᵢₙ, also referred to as the changing load current here, causes the behavior in the capacitor voltage V_{cap} and the capacitor current I_{cap} shown in FIG. 2. First, a sudden increase in load current (from low to high) causes a droop in the capacitor voltage V_{cap}, which primarily may be due to the Iᵢₙ*R voltage drop across the finite output resistance R (not shown) of the power source 3. This droop, ΔV, is a function of the current Iᵢₙ at its high level, as well as the finite output resistance R of the power source 3 and any other series resistance in the current paths between the power source 3 and the capacitor 8. At the same time, the capacitor current I_{cap}, which is initially at zero (because the capacitor 8 is fully charged initially), makes an abrupt negative dive as shown. This transient in I_{cap} is a sudden outflow of charge from the capacitor 8 into the common node 7, which assists in supplying the increased load current Iᵢₙ. The capacitor current I_{cap}, however, recovers quickly back to zero, as the power source 3 takes over the task of providing the entire load current.

The capacitor voltage V_{cap} remains at its droop level (due to the increased load current and the finite output resistance of power source 3), until there is an abrupt decrease in the load current Iᵢₙ, from high to low as shown. This causes the capacitor voltage to rise, because the pass current Iₚₐₛₛ is dropping rapidly (due to the lower Iᵢₙ). At the same time, there is another transient in the capacitor current, this time a sharp rise above zero due to the need to charge the capacitor 8 by the amount ΔV (to bring the capacitor voltage back up to the original output voltage of the power source 3 while the load current is low. As depicted in FIG. 2, this cycle is repeated, in this case at a period (frequency) that is within the audible frequency range.

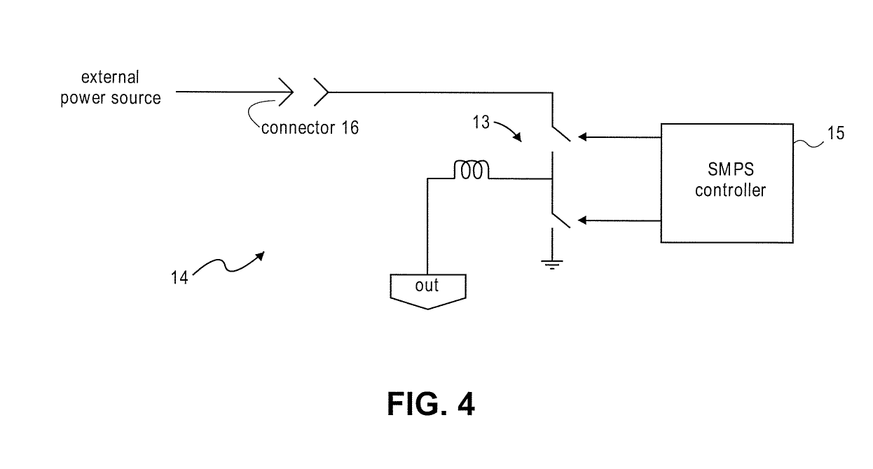

The transients in the capacitor current I_{cap} such as depicted in FIG. 2 are believed to contribute to the creation of acoustic noise due to physical vibration of the capacitor 8 (which is ultimately caused by the pulsing-type activity of the system components 6 reflected in Iᵢₙ(t)). In accordance with an embodiment of the invention, the series pass circuit 4 (see FIG. 4) is controlled so as to increase its resistance to the pass current, when the reporting signal 5 indicates a transition of one or more of the system components 6 from being active or more active (corresponding to Iᵢₙ being high) to being inactive or less active (corresponding to Iᵢₙ being low). This increase in resistance to the pass current Iₚₐₛₛ results in the transient in the capacitor current I_{cap} being controlled or softened as shown (by having smaller amplitude than an otherwise uncontrolled transient). The uncontrolled transient would occur if the series pass circuit 4 had remained fully on (exhibiting very small or essentially zero resistance to the pass current). The effect of the controlled resistance in the series pass circuit 4 is also visible in the capacitor voltage V_{cap}. Here, the increased resistance to the pass current results in a slower rise of the capacitor voltage (to recover from the ΔV droop), as compared to an abrupt or fast rise (shown as dotted lines in FIG. 2). The latter would occur if the series pass circuit were fully turned on or had very small or essentially negligible resistance to the pass current. Note that what is shown in FIG. 2 is the effect of increasing the resistance in the series pass circuit 4 during the phase where the capacitor 8 is being recharged.

It has been determined that the acoustic energy produced by the capacitor 8 may be proportional to the voltage droops (the ΔV depicted in FIG. 2) across the capacitor 8. In one case, simulation results show that the spectral content of V_{cap} exhibits significantly lower magnitudes at certain frequency components, and especially in those components that are likely to be more sensitive to the human ear, when the resistance of the series pass circuit 4 is increased as explained above, during the initial part of the phase or time interval shown in FIG. 2 in which Iᵢₙ has transitioned from high to low. This is the phase where the capacitor current (while charging the capacitor) becomes controlled (versus uncontrolled), and the capacitor voltage recovers slowly (rather than fast) from its droop. The spectral content of V_{cap} in that scenario confirms that on average (over many cycles) there is less audible noise being produced by the capacitor 8.

Still referring to FIG. 2 and FIG. 1, in one embodiment, in addition to the resistance of the series pass circuit 4 being increased by the control circuit 10, the control circuit 10 may also be configured to decrease the resistance when the reporting signal 5 indicates a transition of the system component 6 from being inactive or less active, to being active or more active. This is reflected, as an example, in FIG. 2 where the transition of Iᵢₙ from low to high (corresponding to a transition in one or more system components 6 from being inactive or less active, to being active or more active) coincides with a decrease in the resistance (to the pass current Iₚₐₛₛ) of the series pass circuit 4. The decreased resistance allows the capacitor current I_{cap} to abruptly swing negative (negative transient, meaning in this case that the capacitor is rapidly discharging) as shown in FIG. 2, as to assist in supplying the increased load current Iᵢₙ being demanded by the system components 6. This helps maintain the role of the capacitor 8 as, for example, a decoupling or power supply bypass capacitor (so that the capacitor 8 can continue to assist the power source 3 in providing a stable and clean (low ripple) dc voltage to the power supply inputs of the system components 6.

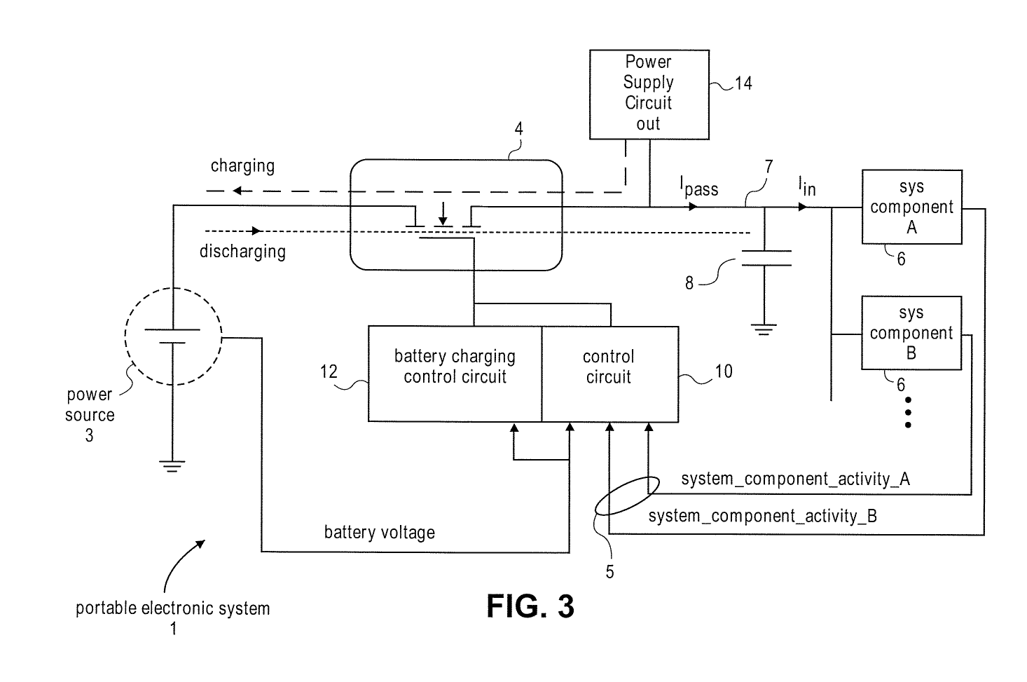

Referring back to FIG. 1, the series pass circuit 4 may be implemented as a pass transistor having a first carrier electrode that is directly connected to the first side, a second carrier electrode that is directly connected to the second side, and a control electrode that is directly connected to the control input. An example of such an embodiment will be described below in connection with FIG. 3, where in that case the transistor is an insulated gate field effect transistor. Other circuit arrangements are possible, including ones with multiple pass transistors connected in parallel and controlled by the same control input. Each of the one or more pass transistors of the series pass circuit 4 can be used to conduct the pass current while being partially on, when exhibiting the desired increased resistance, rather than fully on or fully off. In one embodiment, the transistor is voltage controlled in that the voltage on its control electrode will set its operating mode (or its resistance to the pass current). For example, a field effect transistor in which the pass current is to flow essentially through the two carrier electrodes being the drain and source terminals, can be operated in either fully on (or saturation) mode, in cut-off mode, or in a partially on mode in which the field effect transistor is in neither saturation nor cut-off mode but rather in a so-called linear or resistance mode, as a direct function of its gate electrode voltage.

In one embodiment, a pass transistor of the series pass circuit 4 is operated in at least two stable states, one that presents a high resistance and another that presents a low resistance to the pass current, by appropriately setting the voltage on its control electrode. In one embodiment, the high resistance is larger than the low resistance by a factor of at least 10 (for purposes of achieving the controlled transient in the capacitor current—see FIG. 2). In another embodiment, the resistance is increased by a factor of at least 50 (when transitioning from the low resistance state to the high resistance state). In one embodiment, the low resistance state is when the pass transistor is fully on or saturated, while the high resistance state is when it is partially on (e.g., linear region, triode mode, or ohmic mode of operation of the transistor).

As suggested above, in one embodiment, a pass transistor of the series pass circuit 4 may be operated in its fully on or saturation mode, during the phase or time interval of each cycle where the load current (the sum of the power supply input currents of the system components 6) has abruptly risen from a low level to a high level (see FIG. 2, Iᵢₙ). For example, for a typical field effect transistor, the low resistance state may have an R_{ds(on)} in the range of 5 milliohms to 50 milliohms while the high resistance state may be in the range of 0.5 ohms to 5 ohms. These, however, are only examples such that the particular selection of resistance to the pass current may be different depending on various factors. However, it should be recognized that when selecting the increased resistance level, there comes a point where the resulting reduction in acoustic energy (produced by the capacitor 8) is not as significant as compared to the resulting slowdown in the recovery of the capacitor voltage V_{cap}. See FIG. 2, where the time interval needed to recover from the droop ΔV may become too long, thereby risking a reduction in the average dc voltage (over several cycles) at the common node 7 that in turn may lead to a possible brownout where one or more of the system components 6 malfunctions due to not receiving a sufficient power supply input voltage.

Turning now to FIG. 3, this is a combined circuit schematic and block diagram of a portable electronic system 1 in which the capacitor 8 may be potentially a singing capacitor. This embodiment is somewhat similar to the embodiment of FIG. 1 in that the capacitor 8 has its upper terminal directly connected to the power supply inputs of several system components 6 (A, B, . . . ), at the common node 7. A second side of the series pass circuit 4 is also directly connected to the common node 7, while a first side of the series pass circuit 4 is connected to the power source 3. However in this case, the power source 3 is a battery whose positive (power supply) terminal is connected to the first side of the series pass circuit 4, while its negative (power return) terminal is connected to the same ground as the capacitor 8. Although not shown, the power source 3 may include additional circuitry such as a battery gas gauge and overcurrent protection circuits. In one embodiment, such battery circuitry may be integrated into a separate battery pack (together with the battery cell core), which pack may be separate from the one or more printed circuit boards (e.g., flex circuits) on which the series pass circuit 4, capacitor 8, one or more of the system components 6, battery charging control circuit 12, and control circuit 10 are mounted.

In the portable embodiment shown in FIG. 3, the series pass circuit 4 conducts the pass current Ipass in the direction shown, as a battery discharging current supplied by the battery (power source 3). In addition, in the reverse direction, the series pass circuit conducts a battery charging current supplied by the power supply circuit 14. Here, the current through the series pass circuit (charging or discharging) is through the same pass transistor, depicted in this example as an insulated gate field effect transistor.

The battery charging current is provided by the power supply circuit 14 whose output node (“out”) is directly connected to the common node 7. The system is “portable” in the sense that the system components 6 are powered by the battery (power source 3), when the power supply circuit 14 is not connected to an external power source (not shown). In the portable mode of operation, the pass current Iₚₐₛₛ is primarily supplied by the battery (power source 3), as the battery discharging current, not by the power supply circuit 14. However in charging mode (when an external power source is connected through the power supply circuit 14), some of the pass current Ipass may be supplied by the battery (power source 3) while some of it is supplied by the power supply circuit 14.

A battery charging control circuit 12 serves to control the resistance of the series pass circuit 4, so as to modulate the battery charging current, while in charging mode. Control of the series pass circuit 4 for that purpose may be in accordance with a battery charging profile (e.g., constant voltage, constant current or a combination thereof) using one or more measured parameters, including typically at least the battery voltage (as shown) and the charging current.

Similar to the embodiment of FIG. 1, the control circuit 10 also serves to control the series pass circuit 4, to increase resistance to the pass current (in the series pass circuit 4) in accordance with one or more reporting signals 5 that indicate whenever one of the system components 6 is either more active or less active. Also similar to the embodiment of FIG. 1, the capacitor 8 may be a decoupling or power supply bypass capacitor that acts like a shunt to ground, in order to, for example, reduce voltage ripple or other voltage noise on the common node 7 which is directly connected to the power supply inputs of the system components 6. The system components 6 may also be as described above in connection with FIG. 1, where they draw power through their power supply inputs in pulses or bursts, occurring at a frequency in the human audible range (thereby causing acoustic noise to be created by the capacitor 8 as a singing capacitor). To alleviate that situation, the control circuit 10 may operate as described above in connection with FIG. 1, by responding to the reporting signal 5 (also referred to as an indictor signal which indicates when the system component 6 is active or more active, as well are when the system component is inactive or less active). The control circuit 10 will respond to the reporting signal 5 by adjusting a control signal that it may supply to the control input of the series pass circuit 4, in order to, for example, increase the resistance to the pass current Iₚₐₛₛ during a certain time interval or phase of each cycle, as governed by the reporting signal 5. See also the discussion above in connection with the timing diagram of FIG. 2 all of which may also be applied to the embodiment of FIG. 3.

The reporting signal 5 may be an indicator signal that contains the timing of when a given one or more of the system components 6 is drawing more power through it through its power supply input, versus less power. As explained above in connection with FIG. 1, the reporting signal 5 (indicator signal) may indicate when a TDMA transmitter is active, e.g. transmitting communications channel payload from the portable system over the air to a remote device, and when it is inactive, e.g. not transmitting the communications channel payload. The reporting signal 5, in this manner, allows the control circuit 10 to “know” when the load current Iᵢₙ is pulsing, and to respond by appropriately timing the increase in resistance to the series pass current Iₚₐₛₛ to match that of the pulsing activity (again as described above in connection with FIG. 2 for example). In one embodiment, the reporting signal 5 may be a GSM blank signal that is produced by a conventional wireless communications baseband processor that can give advance warning to the control circuit 10 that the TDMA transmitter is about to go active. Note, however, that other types of pulse-type activity by the system components 6 may be reported in the reporting signal 5, in order to alleviate the potential of the capacitor 8 becoming a singing capacitor.

In the embodiment of FIG. 3, when the pass current Iₚₐₛₛ is primarily the battery discharging current provided by the battery (power source 3), the control circuit 10 adjusts the series pass circuit 4 so that resistance to the battery discharging current is increased, when the system component 6 transitions from being active or more active, to being inactive or less active. Similar to the embodiment of FIG. 1, the resistance may be increased by a factor of at least ten, or more particularly by at least fifty. In addition, the control circuit 10 may adjust the control signal it supplies to the control input of the series pass circuit 4, so that resistance to the battery discharging current is also decreased. This may take place when the system component 6 transitions from being inactive or less active, to being active or more active. In that case, the resistance may be decreased by, for example, a factor of at least ten, or more particularly by a factor of at least 50.

With respect to the embodiment of FIG. 3, note that in the particular circuit schematic shown, the battery charging control circuit 12 and the control circuit 10 are coupled to the same control input of the series pass circuit 4. Here, not only is the same pass transistor in the series pass circuit 4 shared for both charging and discharging currents, its control electrode is also shared, for purposes of controlling the battery charging current as well as controlling the battery discharging current. This means that some synchronization or communication logic circuitry is needed, that constitutes parts of the battery charging control circuit 12 and/or the control circuit 10, so that there is a smooth and conflict-free handoff between the two control circuits, between when the battery (power source 3) is being charged and when the battery is discharging. For that purpose, there may be additional control signals that are provided to the battery charging control circuit 12 and the control circuit 10, including, for example, a status signal that indicates whether or not an external power supply has been connected via the power supply circuit 14, a signal that indicates that battery charging may begin (in response to which the control circuit 10 may wish to “relinquish” its control of the series pass circuit 4).

A further parameter that may be used to assist the decision-making process by the control circuit 10, as to whether or not to decrease the resistance of the series pass circuit 4, is the present voltage of the battery (power source 3). For example, the control circuit 10 may be configured to detect that the battery voltage is below a set threshold, and in response not modulate the resistance to the pass current (and instead maintain the series pass circuit 4 in a fully on state, or relinquish control of the series pass circuit 4 to the battery charging control circuit). This may help avoid the possibility of a brownout occurring in one of the system components 6, when the voltage on the common node 7 drops too low, due to the battery voltage being too low to begin with and worsened by the slow recovery from droop—see FIG. 2.

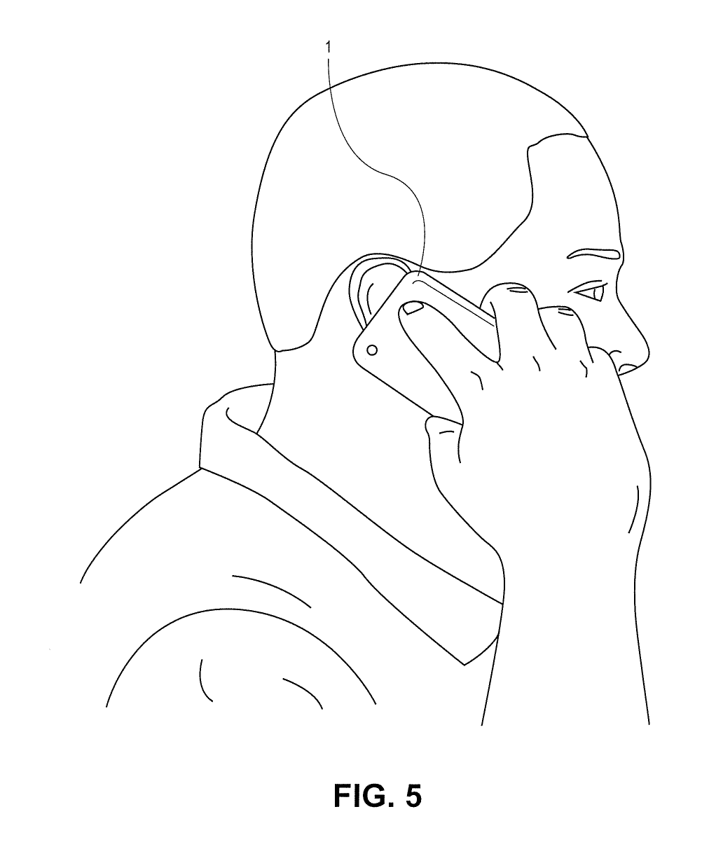

The embodiment of FIG. 3 is a portable electronic system 1 that may, for example, be a portable consumer electronic device whose housing contains the series pass circuit 10, the battery (power source 3), the capacitor 8, the system components 6, and the control circuit 10, all of which may be integrated within the housing. In one embodiment, the battery charging control circuit 12 is also integrated within the same housing of the portable electronic system 1. Examples of such devices include smartphones, e.g. a mobile phone, as depicted during handset mode usage in FIG. 5, tablet computers, and laptop computers. To enable the charging of the battery (power source 3) in such instances, the second side of the series pass circuit 4 (at the common node 7) is connected to the power supply circuit 14. The latter serves to couple to an external power source, e.g. external to the housing of the portable device, that will supply the battery charging current.

In one embodiment, the power supply circuit 14 may be simply a pair of power supply lines that connect the common node 7 and the system ground to a pair of dc input pins of a connector that is built into the housing of the portable device. The external power source in that case may be a 120 Volt ac to dc wall power adapter, or it may be a computer peripheral communications bus device such as a Universal Serial Bus (USB) host. In another embodiment, the power supply circuit 14 may be more complex. For example, it may include a dc voltage regulator, or an ac to dc power converter. In all of these instances, the power needed to supply the battery charging current is delivered through a wired path, from an external device that is outside of the housing of the portable device. As an alternative to a wired path for delivering such power, the power supply circuit 14 may be designed to interface with a n external, wireless inductive charging station, which allows a conversion of power through a wireless inductive mechanism. In that case, the power supply circuit 14 may also need to convert the ac power that is inductively received into dc power that it supplies onto the common node 7.

The power supply circuit 14 may include a dc-dc converter, including for example a boost converter, or it may include a step down voltage regulator that may be a linear regulator. In the case of FIG. 4, the power supply circuit 14 is depicted there as a switch mode power supply (SMPS). In that case, an SMPS controller 15 (e.g., a buck converter controller or a boost converter controller) generates the control signals to one or more solid state power switches within each phase 13 of the power converter, where there may be multiple phases (not shown) such that each phase is connected to the output node (out) as shown. Input to the power converter is from a connector 16, one-half of which is integrated in the portable device and a mating half is part of an external power source (not shown), such as an-dc wall power adapter, or an automobile 12-volt cigarette lighter connector.

Another embodiment of the invention may be viewed as a method for operating an electronic system, in which power is being provided to a power supply input of a system component of the system. This power is provided through a series pass circuit. A local energy supply to the power supply input is in the form of a shunt capacitor (e.g., capacitor 8—see FIG. 1). During the pulse type activity of a system component that occurs in cycles, the resistance of the series pass circuit is increased in each cycle, so that the capacitor current (e.g., the current that serves to charge the capacitor at the end of a voltage droop event on the capacitor's terminal) is controlled, in accordance with a reporting signal that indicates whenever the system component is more active versus less active. In one embodiment, the power being provided to the power supply input of the system component includes providing that power from a battery (e.g., in a portable electronic device). This method is effective to reduce the amount or level of acoustic noise produced by vibration of the capacitor.

The reporting signal indicates whenever the system component is active and whenever the system component is inactive, where such reporting exhibits a frequency that is in the audible human range and that is present in the acoustic noise produced by the vibrating capacitor. Control of the series pass circuit may in a sense be synchronized to the timing of the reporting signal, in order to alleviate the singing capacitor effect. In one embodiment, the reporting signal indicates whenever the system component is transmitting a communication channel payload, and whenever the system component is not transmitting any communication channel payload (where this cycle of transmission and non-transmission repeats at a frequency that is in the human audible range). The reporting signal may alternatively be indicating other pulse-type activity of the system component that would cause the capacitor to produce acoustic noise (or become in effect a singing capacitor).

In a more particular embodiment, the resistance of the series pass circuit is increased in accordance with the reporting signal in such a way that the resistance is increased only when the reporting signal indicates that the system component is transitioning from being active or more active, to being inactive or less active. In one embodiment, the resistance of the series pass circuit is then reduced and kept at a low resistance state (e.g., at the lowest possible or available resistance, such as in a pass transistor that is fully on), during each phase or time interval of the reporting signal that indicates the system component is active or more active. To explain, referring for example back to the waveforms in FIG. 2, the period of the load current Iᵢₙ (representing the power supply input currents of one or more of the system components 6) can be divided into for example two phases, namely one phase in which the current is high (system components are active) and one phase in which the current is low (system components are inactive). In one embodiment, the control signal at the control input of the series pass circuit 4 (see FIG. 1) also has two phases that are similar in timing to those of the load current Iᵢₙ depicted in FIG. 2, where the control signal signals a high resistance state while the load current is low, and a low resistance state during the phase in which the load current is high.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, although a single capacitor 8 is depicted in FIG. 1, there can be additional (potentially singing) capacitors that are directly connected to the common node 7, including power supply bypass capacitors that may be located closer to the actual integrated circuit (IC) package of one of the system components 6 (and may be soldered to the same printed circuit board to which the IC package is also soldered). Also, while the series pass circuit 4 was illustrated above using a pass transistor in FIG. 3, other types of active solid-state devices that have at least three terminals (two for the pass current and one for the control input), or other complex circuitry that controls the pass current, may be used in the series pass circuit. The description is thus to be regarded as illustrative instead of limiting.

What is claimed is:

1. An electronic system comprising:
a series pass circuit to conduct a pass current between a first side and a second side, in accordance with a control input;
a power source coupled to the first side;
a capacitor coupled to the second side;
a system component, of the electronic system, whose power supply input is coupled to the capacitor; and
a control circuit coupled to the control input of the series pass circuit so as to increase resistance to the pass current, in the series pass circuit, in accordance with a reporting signal that indicates whenever the system component is one of a) more active or b) less active.

2. The electronic system of claim 1 wherein the series pass circuit comprises a transistor having a first carrier electrode that is directly connected to the first side, a second carrier electrode that is directly connected to the second side, and a control electrode that is directly connected to the control input.

3. The electronic system of claim 1 wherein the power source is a battery.

4. The electronic system of claim 3 further comprising:
a battery charging control circuit coupled to control the series pass circuit so as to modulate battery charging current into the battery, via the series pass circuit.

5. The electronic system of claim 4 further comprising a power supply circuit coupled to the second side of the series pass circuit to provide the battery charging current.

6. The electronic system of claim 4 further comprising a portable consumer electronic device housing in which the series pass circuit, the battery, the capacitor, the system component, and the control circuit are integrated,
and wherein second side of the series pass circuit is to be coupled to an external power source which is external to the housing.

7. The electronic system of claim 1 wherein the control circuit is to increase the resistance of the series pass circuit when the reporting signal indicates a transition of the system component from being active or more active, to being inactive or less active.

8. The electronic system of claim 7 wherein the control circuit is to decrease the resistance of the series pass circuit when the reporting signal indicates a transition of the system component from being inactive or less active, to being active or more active.

9. A portable electronic system, comprising:
a system component, of the portable electronic system, having a power supply input;
a series pass circuit;
a battery to provide battery discharging current to the power supply input of the system component through the series pass circuit;
a capacitor directly connected to the power supply input of the system component;
a power supply circuit to provide battery charging current into the battery through the series pass circuit;
a battery charging control circuit to control the series pass circuit so as to modulate the battery charging current; and
a control circuit to control the series pass circuit so as to modulate the battery discharging current.

10. The portable electronic device of claim 9 wherein the system component draws power through its power supply input in pulses, occurring at a frequency in the human audible range.

11. The portable electronic device of claim 10 wherein the system component is a radio communications component having a time division multiple access (TDMA) transmitter that draws the power in pulses.

12. The portable electronic device of claim 10 wherein the control circuit receives an indicator signal that indicates a) when said system component is active or more active, and b) when said system component is inactive or less active, and in response to the indicator signal adjusts a control signal to the series pass circuit.

13. The portable electronic device of claim 9 wherein the control circuit receives an indicator signal that contains timing of when the system component is drawing more power through it power supply input, versus less power.

14. The portable electronic device of claim 12 wherein the control circuit adjusts the series pass circuit so that resistance to the discharging current, in the series pass circuit, is increased when the system component transitions from being active or more active, to being inactive or less active.

15. The portable electronic device of claim 14 wherein the resistance is increased by a factor of at least ten.

16. The portable electronic device of claim 12 wherein the control circuit adjusts the series pass circuit so that resistance to the discharging current, in the series pass circuit, is decreased when the system component transitions from being inactive or less active, to being active or more active.

17. The portable electronic device of claim 16 wherein the resistance is decreased by a factor of at least ten.

18. A method for operating an electronic system, comprising:
providing power to a power supply input of a system component of the system, through a series pass circuit;
providing a local energy supply to the power supply input using a shunt capacitor; and
increasing resistance of the series pass circuit to pass current, in accordance with a reporting signal that indicates whenever the system component is one of a) more active or b) less active.

19. The method of claim 18 wherein providing power to the power supply input of the system component comprises providing the power from a battery.

20. The method of claim 18 wherein the reporting signal indicates whenever the system component is active and whenever the system component is inactive, at a frequency that is in the human audible range.

21. The method of claim 20 wherein the reporting signal indicates whenever the system component is transmitting communication channel payload, and whenever the system component is not transmitting communication channel payload, at a frequency that is in the human audible range.

22. The method of claim 18 wherein increasing resistance of the series pass circuit to pass current, in accordance with the reporting signal, takes place whenever the reporting signal indicates that the system component is transitioning from being active or more active, to being inactive or less active.
